(19) United States
(12) Patent Application Publication
(10) Pub. No.: US 2006/0084046 A1
(43) Pub. Date: Apr. 20, 2006

(54) System and method for assessing the employability of a job applicant

(75) Inventors: Michael L. Brown, Waxahachie, TX (US); Robert J. Landis, Midlothian, TX (US)

Correspondence Address: DOCKET CLERK, P.O. DRAWER 800889, DALLAS, TX, 75380, US

(73) Assignee: SkillsNET Corporation, Waxahachie, TX (US)

(21) Appl. No.: 11/236,918

(22) Filed: Sep. 28, 2005

Related U.S. Application Data
(60) Provisional application No. 60/614,324, filed on Sep. 29, 2004.

(51) Int. Cl. G09B 19/00

(52) U.S. Cl. 434/236

(57) ABSTRACT

A method, system, and computer program provide a plurality of questions to a job applicant. The questions represent standardized questions. The method, system, and computer program receive answers to the plurality of questions from the job applicant. The method, system, and computer program determine one or more employability characteristics of the job applicant using the answers to the plurality of questions. The one or more employability characteristics identify how employable the job applicant is based on qualifications of the job applicant.

### CROSS-REFERENCE TO RELATED APPLICATIONS

This application claims priority under 35 U.S.C. § 119(e) to U.S. Provisional Patent Application No. 60/614,324 filed on Sep. 29, 2004, which is hereby incorporated by reference.

### TECHNICAL FIELD

This disclosure relates generally to human resource management systems and more specifically to a system and method for assessing the employability of a job applicant.

### BACKGROUND

An employment interview is an important tool for learning the capabilities, experience, and interests of candidates for employment. However, numerous interviews are often necessary to find one or more qualified candidates for a job opening. This means that the interview process may take an extended amount of time. Moreover, many unqualified candidates may be interviewed during this process, which also lengthens the process needed to fill a job opening.

### SUMMARY

This disclosure provides an improved system and method for assessing the employability of a job applicant.

In one aspect, a method, system, and computer program provide a plurality of questions to a job applicant. The questions represent standardized questions. The method, system, and computer program receive answers to the plurality of questions from the job applicant. The method, system, and computer program determine one or more employability characteristics of the job applicant using the answers to the plurality of questions. The one or more employability characteristics identify how employable the job applicant is based on qualifications of the job applicant.

In a particular aspect, the one or more employability characteristics identify at least one of the job applicant's willingness to work in at least one of: different social environments, different physical environments, and different work schedules. In another particular aspect, the one or more employability characteristics identify at least one of the job applicant's use of a plurality of skills, the job applicant's competence at using the plurality of skills, the job applicant's readiness to begin employment, the job applicant's perceived employability, and the job applicant's motivations for seeking employment.

Other technical features may be readily apparent to one skilled in the art from the following figures, descriptions, and claims.

### BRIEF DESCRIPTION OF DRAWINGS

For a more complete understanding of this disclosure, reference is now made to the following description, taken in conjunction with the accompanying drawings, in which:

FIG. 1 illustrates an example system for assessing the employability of a job applicant according to one embodiment of this disclosure;

FIG. 2 illustrates an example method for assessing the employability of a job applicant according to one embodiment of this disclosure.

### DETAILED DESCRIPTION OF EXAMPLE EMBODIMENTS

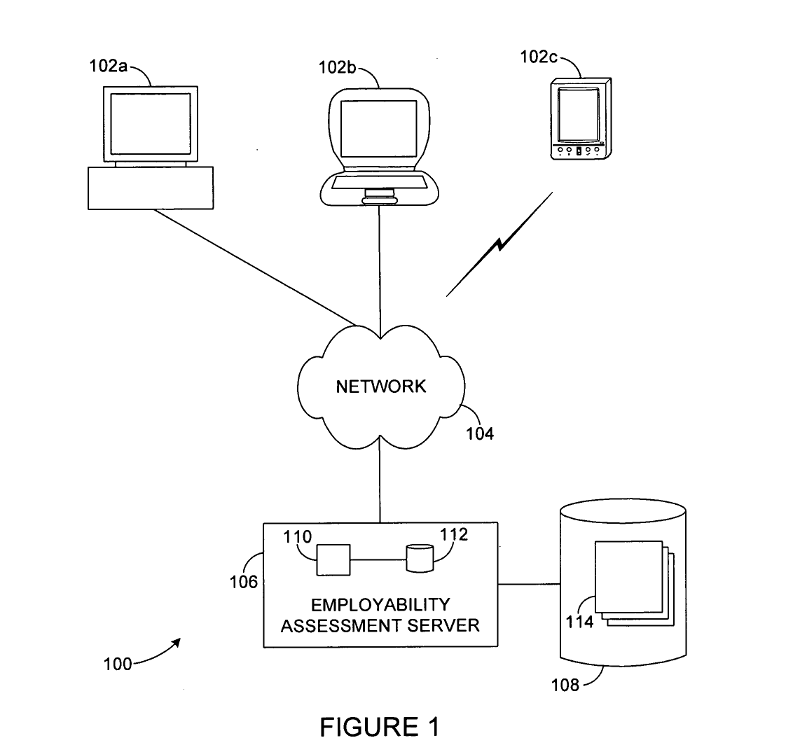

FIG. 1 illustrates an example system 100 for assessing the employability of a job applicant according to one embodiment of this disclosure. In the illustrated example, the system 100 includes multiple user devices 102a-102c, a network 104, an employability assessment server 106, and a database 108. Other embodiments of the system 100 may be used without departing from the scope of this disclosure.

In one aspect of operation, a user uses one of the user devices 102a-102c (referred to as “user devices 102”) to access the employability assessment server 106. The user may represent, for example, a potential job applicant. The employability assessment server 106 provides various questions to the user and receives answers from the user. The employability assessment server 106 uses the answers to evaluate the user's interests, skills, and other qualifications. The employability assessment server 106 also uses this information to match the job applicant to job openings. In this way, the likelihood of matching qualified job applicants to job openings increases, and the information collected or generated by the employability assessment server 106 may be used by workforce counselors or other personnel to recommend training and education for the job applicants.

In the illustrated embodiment, each user device 102 is capable of communicating with the network 104. In this document, the term “each” refers to each of at least a subset of the identified items. Each user device 102 represents any suitable device, system, or portion thereof that allows a user to communicate and interact with the employability assessment server 106. For example, a user device 102 allows a user to receive questions from and provide answers to the employability assessment server 106.

In this particular example, the user devices 102 include a desktop computer, a laptop computer, and a personal digital assistant. Each of these user devices 102 communicates over a wireline or wireless connection. These user devices 102 are for illustration only. Any other or additional computing or communication devices may be used in the system 100. Each user device 102 includes any hardware, software, firmware, or combination thereof for accessing the employability assessment server 106.

The network 104 is capable of communicating with the user devices 102 and the employability assessment server 106. The network 104 facilitates communication between components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

The employability assessment server 106 is coupled to the network 104 and the database 108. In this document, the term “couple” and its derivatives refer to any direct or indirect communication between two or more elements, whether or not those elements are in physical contact with one another. The employability assessment server 106 supports the employability assessment of a potential job applicant. For example, the employability assessment server 106 may provide employability questions to a user and receive answers from the user. The employability assessment server 106 evaluates the answers and determines one or more employability characteristics associated with the job applicant. The employability characteristics represent different indicators that identify how employable a job applicant is based on the skills, interests, and other qualifications of the applicant. The employability assessment server 106 may use the collected and/or generated information in any suitable manner. As an example, the employability assessment server 106 may attempt to match the job applicant to one or more job openings.

The employability assessment server 106 includes any hardware, software, firmware, or combination thereof for performing or otherwise supporting an employability assessment. As a particular example, the employability assessment server 106 may include one or more processors 110 and one or more memories 112 containing data and instructions used by the one or more processors 110. Also, the employability assessment server 106 may receive input from the users in any suitable manner, such as through the use of a web-based interface.

The database 108 is coupled to the employability assessment server 106. The database 108 stores various information used by the employability assessment server 106 to perform the employability assessments. For example, the database 108 may include one or more sets of employability questions 114. Each question set 114 contains one or more questions used to evaluate the interests, skills, and other qualifications of a job applicant. The employability assessment server 106 accesses and uses the questions in the question sets 114 during an assessment of a user. The database 108 includes any hardware, software, firmware, or combination thereof for storing and facilitating retrieval of information. The database 108 also uses any of a variety of data structures, arrangements, and compilations to store and facilitate retrieval of information.

One example of the various question sets 114 used to evaluate a job applicant is shown in Appendix A. In this example, the questions are divided into four question sets 114 (identified as sections 1 through 4 in Appendix A). The question sets 114 are used to evaluate a job applicant's work preferences, skills and unique enhancing factors impacting employability, work readiness and perceived employability, and motivations. In particular embodiments, these question sets 114 are “standardized,” meaning that the same question sets 114 are used to evaluate all job applicants regardless of the applicants' differing skills, education levels, or desired work.

The question set 114 used to evaluate a job applicant's work preferences identifies the ability or willingness of the applicant to accept employment in different environments. For example, the questions in this question set 114 may represent yes/no questions asking whether a job applicant is willing to work in different social environments, physical environments, and work schedules. This question set 114 may be used to narrow the job openings for which the job applicant is qualified.

The question set 114 used to evaluate a job applicant's skills and enhancing factors identifies the applicant's perceived ability to perform fundamental skills needed for any given job. This question set 114 also identifies different characteristics relevant to an applicant's prior experiences and capabilities that may distinguish the applicant from other applicants. For example, the questions in this question set 114 may require the job applicant to rank their usage of and competence at certain skills, such as basic and interpersonal skills. The questions in this question set 114 may also ask a job applicant to identify job training, driver's licenses, foreign language capabilities, and education level. The employability assessment server 106 could provide a definition of each skill to facilitate the ranking. In particular embodiments, these questions may be asked using yes/no questions, pull down menus, and open-ended responses.

The question set 114 used to evaluate a job applicant's readiness and perceived employability identifies how prepared the applicant is for employment and how the applicant has previously attempted to find employment. For example, the questions in this question set 114 may ask a job applicant to identify how confident the applicant is at applying for a job, searching for a job, and evaluating a job opening. In particular embodiments, the job applicant answers the questions in this question set 114 using a scale.

The question set 114 used to evaluate a job applicant's motivations identifies the applicant's reasons for searching for employment. For example, the questions in this question set 114 may ask a job applicant to identify the importance of different motivations or factors in the applicant's search for employment, such as financial rewards, societal status, and working conditions. In particular embodiments, the job applicant answers the questions in this question set 114 using a scale.

The job applicant's answers to the questions in the question sets 114 are then scored. For example, in the first question set 114, the employability assessment server 106 may determine how likely the job applicant is to work in varying social environments, physical environments, and work schedules. In the second question set 114, the employability assessment server 106 may generate three scores for each skill, two scores reflecting the job applicant's usage of and competence at the skills and a third score representing an average of the first two scores. The employability assessment server 106 may also provide a one-line or multi-line summary for each enhancing factor question, where the summary highlights the job applicant's answers. In the third question set 114, the employability assessment server 106 may average the applicant's scores in each of the different categories of questions. In the fourth question set 114, the employability assessment server 106 may average the answers for each of the various motivations. Other techniques for scoring the job applicant's answers may also be used.

The results produced by scoring the job applicant's various answers may be used in any suitable manner. For example, the employability assessment server 106 may generate a report summarizing the job applicant's results. As a particular example, the report could include the job applicant's answers to the various questions and the scores calculated by the employability assessment server 106. The report could also include comments about the results, such as comments about the job applicant's ability to work in different environments, an identification of the most and least used skills, a summary of any enhancing factors, and when the job applicant should seek advice from a counselor.

The reports produced by the employability assessment server 106 may be used by a number of people and in a number of ways. For example, a job applicant, an employer, or a workforce counselor may each receive a different report, and each person may use the reports in any suitable manner. As examples, the job applicant and employers could use the applicant's answers to the work preference question set 114 to eliminate jobs that the applicant is unwilling to accept. A workforce counselor could use the applicant's answers to the skills question set 114 to recommend supplemental job training. Example reports are shown in Appendix B.

In addition, the employability assessment server 106 could use the job applicant's answers to locate job openings for which the job applicant is qualified. For example, the employability assessment server 106 could use the work preference answers to eliminate jobs the applicant is unwilling to accept. The employability assessment server 106 could also use the answers to the skill and enhancing factor questions and the motivation questions to identify jobs for which the applicant may be qualified and may be willing to accept.

Although FIG. 1 illustrates one example of a system 100 for assessing the employability of a job applicant, various changes may be made to FIG. 1. For example, the system 100 may include any number of user devices 102, networks 104, servers 106, and databases 108. Also, while FIG. 1 illustrates the use of a server 106 in the system 100, the functionality of the server 106 could be implemented on other device(s), such as a desktop computer or a laptop computer. Further, while FIG. 1 illustrates that one database 108 is coupled directly to the interview support server 106, any number of databases 108 may reside at any location or locations accessible by the server 106. In addition, the question sets 114 and reports shown in Appendix A and Appendix B are for illustration only. Other or additional questions or question sets 114 may be used in the system 100, and other or additional reports could be generated.

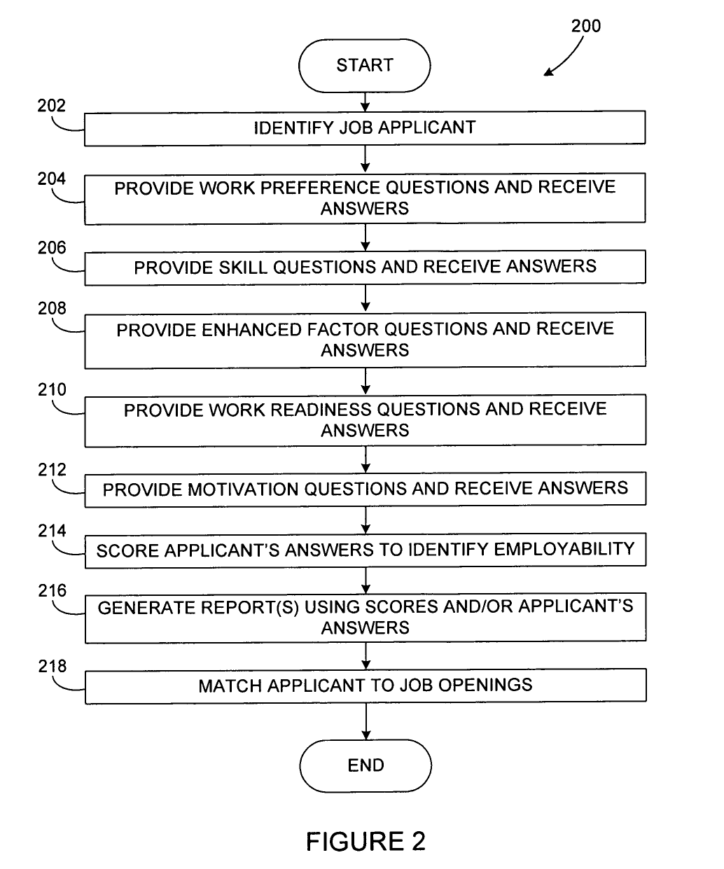

FIG. 2 illustrates an example method 200 for assessing the employability of a job applicant according to one embodiment of this disclosure. For ease of explanation, the method 200 is described with respect to the interview support server 106 operating in the system 100 of FIG. 1. The method 200 could be used by any other suitable device and in any other suitable system.

The interview support server 106 identifies a job applicant at step 202. This may include, for example, the interview support server 106 determining that a user using a device 102 is attempting to access the interview support server 106. This may also include the interview support server 106 receiving authentication information from the user, such as a username and password. If the user is not registered with the interview support server 106, this may further include the interview support server 106 collecting various information about the user and setting up a user account.

The interview support server 106 provides the job applicant with one or more questions related to the applicant's work preferences and receives answers at step 204. This may include, for example, the interview support server 106 providing questions asking whether the applicant is willing to work in different social environments, physical environments, and work schedules. As a particular example, this may include the interview support server 106 receiving answers to various yes/no questions.

The interview support server 106 provides the job applicant with one or more questions related to the applicant's skills and receives answers at step 206. This may include, for example, the interview support server 106 identifying different basic skills and asking the applicant to rank his or her usage of each skill and competence for each skill. As a particular example, this may include the interview support server 106 receiving answers in the form of rankings on a scale. This may also include the interview support server 106 providing a definition or description of each skill.

The interview support server 106 provides the job applicant with one or more questions related to the applicant's unique enhancing factors and receives answers at step 208. This may include, for example, the interview support server 106 asking the applicant whether the applicant has occupation-specific job training or certain types of driver's licenses. As a particular example, this may include the interview support server 106 receiving answers using yes/no questions, pull down menus, and open-ended responses.

The interview support server 106 provides the job applicant with one or more questions related to the applicant's work readiness and receives answers at step 210. This may include, for example, the interview support server 106 identifying different tasks related to work readiness or perceived employability (such as applying for a job or searching for a job). This may also include the interview support server 106 asking the applicant to rank his or her ability to perform these various tasks. As a particular example, this may include the interview support server 106 receiving answers in the form of rankings on a scale.

The interview support server 106 provides the job applicant with one or more questions related to the applicant's motivation and receives answers at step 212. This may include, for example, the interview support server 106 identifying different motivations (such as salary and possibility of promotion) and asking the applicant to rank the importance of each motivation. As a particular example, this may include the interview support server 106 receiving answers in the form of rankings on a scale.

The interview support server 106 scores the applicant's answers to identify the job applicant's employability at step 214. This may include, for example, the interview support server 106 counting the number of yes or no answers, averaging rankings, and summarizing various answers.

The interview support server 106 generates one or more reports using the applicant's answers and/or the scores at step 216. This may include, for example, the interview support server 106 generating one report for the job applicant, another report for employers, and a third report for a workforce counselor.

The interview support server 106 matches the job applicant with one or more job openings at step 218. This may include, for example, the interview support server 106 using the applicant's answers to identify job openings for which the job applicant qualifies. This may also include the interview support server 106 offering the user an opportunity to apply for one or more of the identified job openings.

Although FIG. 2 illustrates one example of a method 200 for assessing the employability of a job applicant, various changes may be made to FIG. 2. For example, the interview support server 106 may provide any other or additional types of questions. Also, the interview support server 106 could use the job applicant's answers to perform any other or additional functions.

It may be advantageous to set forth definitions of certain words and phrases that have been used within this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method, comprising:
providing a plurality of questions to a job applicant, the plurality of questions comprising standardized questions;
receiving answers to the plurality of questions from the job applicant; and
determining one or more employability characteristics of the job applicant using the answers to the plurality of questions, the one or more employability characteristics identifying how employable the job applicant is based on qualifications of the job applicant.

2. The method of claim 1, wherein the one or more employability characteristics identify the job applicant's willingness to work in at least one of: different social environments, different physical environments, and different work schedules.

3. The method of claim 1, wherein the one or more employability characteristics identify at least one of: the job applicant's use of a plurality of skills and the job applicant's competence at using the plurality of skills.

4. The method of claim 1, wherein the one or more employability characteristics identify at least one of: the job applicant's readiness to begin employment and the job applicant's perceived employability.

5. The method of claim 1, wherein the one or more employability characteristics identify the job applicant's motivations for seeking employment.

6. The method of claim 1, further comprising generating at least one report using at least one of: the received answers and the one or more employability characteristics.

7. The method of claim 1, further comprising matching the job applicant to one or more job openings using at least one of: the received answers and the one or more employability characteristics.

8. A system, comprising:
a memory operable to store a plurality of questions; and
one or more processors collectively operable to:
provide the plurality of questions to a job applicant, the plurality of questions comprising standardized questions;
receive answers to the plurality of questions from the job applicant; and
determine one or more employability characteristics of the job applicant using the answers to the plurality of questions, the one or more employability characteristics identifying how employable the job applicant is based on qualifications of the job applicant.

9. The system of claim 8, wherein the one or more employability characteristics identify the job applicant's willingness to work in at least one of: different social environments, different physical environments, and different work schedules.

10. The system of claim 8, wherein the one or more employability characteristics identify at least one of: the job applicant's use of a plurality of skills and the job applicant's competence at using the plurality of skills.

11. The system of claim 8, wherein the one or more employability characteristics identify at least one of: the job applicant's readiness to begin employment and the job applicant's perceived employability.

12. The system of claim 8, wherein the one or more employability characteristics identify the job applicant's motivations for seeking employment.

13. The system of claim 8, wherein the one or more processors are further collectively operable to generate at least one report using at least one of: the received answers and the one or more employability characteristics.

14. The system of claim 8, wherein the one or more processors are further collectively operable to match the job applicant to one or more job openings using at least one of: the received answers and the one or more employability characteristics.

15. A computer program embodied on a computer readable medium and operable to be executed by a processor, the computer program comprising computer readable program code for:
providing a plurality of questions to a job applicant, the plurality of questions comprising standardized questions;
receiving answers to the plurality of questions from the job applicant; and
determining one or more employability characteristics of the job applicant using the answers to the plurality of questions, the one or more employability characteristics identifying how employable the job applicant is based on qualifications of the job applicant.

16. The computer program of claim 15, wherein the one or more employability characteristics identify the job applicant's willingness to work in at least one of: different social environments, different physical environments, and different work schedules.

17. The computer program of claim 15, wherein the one or more employability characteristics identify at least one of: the job applicant's use of a plurality of skills and the job applicant's competence at using the plurality of skills.

18. The computer program of claim 15, wherein the one or more employability characteristics identify at least one of: the job applicant's readiness to begin employment and the job applicant's perceived employability.

19. The computer program of claim 15, wherein the one or more employability characteristics identify the job applicant's motivations for seeking employment.

20. The computer program of claim 15, further comprising computer readable program code for generating at least one report using at least one of: the received answers and the one or more employability characteristics.

21. The computer program of claim 15, further comprising computer readable program code for matching the job applicant to one or more job openings using at least one of: the received answers and the one or more employability characteristics.

22. A method, comprising:
receiving a plurality of questions, the plurality of questions comprising standardized questions;
allowing a job applicant to provide answers to the plurality of questions; and
receiving a report containing one or more employability characteristics of the job applicant, the one or more employability characteristics determined using the answers to the plurality of questions, the one or more employability characteristics identifying how employable the job applicant is based on qualifications of the job applicant.

23. The method of claim 22, wherein the one or more employability characteristics identify at least one of:
the job applicant's willingness to work in at least one of: different social environments, different physical environments, and different work schedules;
the job applicant's use of a plurality of skills;
the job applicant's competence at using the plurality of skills;
the job applicant's readiness to begin employment;
the job applicant's perceived employability; and
the job applicant's motivations for seeking employment.
